(19) United States
(12) Patent Application Publication
(10) Pub. No.: US 2003/0035100 A1
(43) Pub. Date: Feb. 20, 2003

(54) Automated lens calibration

(76) Inventors: Jerry Dimsdale, Oakland, CA (US); Rick Williams, Orinda, CA (US); William Chen, San Leandro, CA (US)

Correspondence Address: STALLMAN & POLLOCK LLP, 121 Spear Street, Suite 290, San Francisco, CA, 94105, US

(21) Appl. No.: 10/106,018

(22) Filed: Mar. 25, 2002

Related U.S. Application Data
(60) Provisional application No. 60/310,003, filed on Aug. 2, 2001.

(51) Int. Cl. G01B 9/00

(52) U.S. Cl. 356/124

(57) ABSTRACT

An improved approach for correcting lens distortion in an imaging system is disclosed. The method is applicable to systems which include both an image system and a laser scanner. In the method, a comparison is made between the location of laser spots on a remote image as captured by the imaging system with calculated locations of the laser spots generated by the laser scanner. The difference between distorted imaged spots and undistorted computationally determined spot locations is utilized to generate a distortion map. The distortion map is then applied to correct a distorted image.

### PRIORITY CLAIM

The present application claims priority to the U.S. Provisional Patent Application Serial No. 60/310,003 filed Aug. 2, 2001, which is incorporated herein by reference.

### CROSS REFERENCES

Patents:

The following US patents describe apparatus and methods to determine camera position relative to an object coordinate frame, but do not contain references to calibration of camera intrinsic parameters.

Tsai, J. et al, “Method and apparatus for automatic image calibration for an optical scanner”, U.S. Pat. No. 6,188,801 B1, Feb. 13, 2001

Palm, C. S., “Methods and apparatus for using image data to determine camera location and orientation”, U.S. Pat. No. 5,699,444, Dec. 16, 1997

The following patents describe apparatus and methods for calibration of the intrinsic parameters of a camera system based on processing of camera images of a known calibration object.

Davis, M. S., “Automatic calibration of cameras and structured light sources”, U.S. Pat. No. 6,101,455, Aug. 8, 2000

Migdal, A. et al, “Modular digital audio system having individualized functional modules”, U.S. Pat. No. 5,991,437, Nov. 23, 1999

The following patents describe apparatus and methods for filtering background illumination from images acquired with pulse illumination:

Talmi, Y. and Khoo, S., “Temporal filter using interline charged coupled device.” U.S. Pat. No. 5,821,547, Oct. 13, 1998

Kamasz, S. R. et al, “Method and apparatus for real-time background illumination subtraction”, U.S. Pat. No. 5,585,652, Dec. 17, 1996

Farrier, M. G. et al, “Charge coupled device pulse discriminator”, U.S. Pat. No. 5,703,639, Dec. 30, 1997

Publications:

Heikkila, J. and Silven, O. (1996) “A four-step camera calibration procedure with implicit image correction”, Technical report from the Infotech Oulu and Dept. of Electrical Engineering, University of Oulu, Finland. (Available at http://www.ee.oulu.fi/~jth/doc)

Willson, R. G. (1994) “Modeling and calibration of automated zoom lenses”, Technical report from 3M Engineering Systems and Technology (Available at http://www.cs.cmu.edu/~rgw)

Zhang, Zhengyou (1998) “A flexible new technique for camera calibration”, Technical Report MSR-TR-98-71, Microsoft Research (Available at http://research.microsoft.com/~zhang)

K. Levenberg. A method for the solution of certain non-linear problems in least squares. Quart. Appl. Math., 2:164-168, 1944.

D. Marquardt. An algorithm for least-squares estimation of nonlinear parameters. SIAM Journal on Applied Mathematics, 11:431—441, 1963.

### FIELD OF THE INVENTION

The present invention relates to method and apparatus for correcting image distortions resulting from lens configurations of an imaging device. Particularly, the present invention relates to calibration of an image provided by a camera of a topographic scanner such that the image may be utilized for selecting a scanning area and for texture mapping.

### BACKGROUND OF THE INVENTION

Image distortions induced from lens configurations are a common problem in camera devices. Examples of radial distortions are shown if FIGS. 1a and 1b. FIG. 1a illustrates the effect of barrel distortion, where straight grid lines GL captured with a camera are imaged as curves that bend towards the outside of an image frame IF. FIG. 1b illustrates the effect of pincushion distortion, where the straight grid lines GL are imaged as curves that bend towards the center of the image frame IF. The radial distortions become more pronounced towards the image periphery. Besides the radial distortions shown in FIGS. 1a, 1b there exist also asymmetric distortions resulting, for example, from centering errors in the lens assemblies.

Lens systems are preferably configured to keep distortions to a minimum. Nevertheless, it is difficult to eliminate all image distortions. This is particularly true with telephoto lenses, also called zoom lenses or variable lens systems, in which the focal length can be adjusted. In these lens systems, distortion is hard to predict and to control. To correct for image distortions in camera systems, various approaches have been undertaken in the prior art like, for example, photogrammetric calibration and self-calibration.

During photogrammetric calibration, a number of observations are made of an object whose 3D geometry is precisely known. The relationship among the known 3D features in a set of images acquired from the camera is used to extract the extrinsic and intrinsic parameters of the camera system (Tsai 1987, Faugeras 1993).

In a self-calibration system, multiple observations of a static scene are obtained from different camera viewpoints. The rigidity of the scene provides sufficient constraints on the camera parameters using image information alone, so that the 3D geometry of the scene need not be known. Variants of these techniques where only a 2D metric of the scene is required have been developed (Zhang, 1998).

Although the photogrammetric calibration methods are the most robust and efficient methods, the calibration objects that need to be placed in the field of view are difficult and expensive to manufacture and calibrate. In addition, the 3D geometric features of the gauge block must be identified and located to high precision in the imagery provided by the camera system. In addition, the feature localization algorithms must be unbiased with respect to the 3D position and surface angle of the feature within the 3D scene relative to the camera view position (Heikkila and Silven 1996). Similarly, the 2D metric self-calibration methods are dependent upon accurate 2D measurement of the calibration surface features and precision, unbiased localization of the features in the camera images.

Known methods for calibration of fixed-parameter camera lens systems usually require a known calibration object, the 3D geometry of which has been measured and recorded by an independent, traceable measurement means. The calibration object is placed in the field of view of the uncalibrated camera. Images acquired from the camera are used, in conjunction with software, to determine the pixel location of the known 3D geometrical features of the object that appear in the images. Additional software algorithms consider both the 3D object coordinates and the image pixel coordinates of the calibration object features to determine the internal parameters of the camera-lens system.

Calibration of a variable-focus, zoom lens camera system usually increases the calibration effort, since new intrinsic (internal) camera parameters must be determined for each setting of aperture, focus, and zoom. In a prior art method (Willson, 1994), for example, a model of the variable-parameter camera lens may be constructed by applying the fixed-parameter method for a set of lens parameter configurations that spans the range of interest for which the model will be applied. Application of the model for a specific known set of lens settings (e.g. aperture, focus, zoom) involves interpolation of the internal camera parameters from model values determined at the original calibration configurations. This method is applicable to variable-parameter lens systems for which repeatable lens settings can be attained, e.g. for motorized, computer-controlled lens systems. Such a system is relatively complex and requires a tight interrelation between the lens component and the image processing component. An additional effort must be taken to create original calibration information from which the operational correction parameters can be derived.

Calibration of fixed and variable lens systems requires 3D coordinate information within the field of view. The prior art methods of placing calibration objects in the scene are time consuming and inflexible. Therefore, there exists a need for a method and apparatus to calibrate camera lens systems that is simple to use and can be applied both to fixed and variable lens systems, preferably without the need for observing the operational lens configuration. The present invention addresses this need.

In the prior art there exist a number of 3D imaging technologies and systems (for example, U.S. Pat. No. 5,988,862, Kacyra, et al) that provide precision 3D scene geometry. FIG. 2 shows schematically such a light detection and ranging system 1 (LIDAR) that measures the distances to an object 2 by detecting the time-of-flight of a short laser pulse fired along a trajectory LD and reflected back from the different points on the object. To obtain information about an entire scanning scene, the laser is directed along a scanning area SA by means of a mirror unit including two orthogonal mirrors that induce a controlled deflection of the laser beam in both horizontal and vertical directions. In a number of consecutive scanning steps, spaced with the increment angle IA, a point cloud of measured object points is created that is converted into a geometric information of the scanned object 2.

To assist a user in targeting the scanner properly and to define the scanning area, some scanners additionally incorporate a 2D imaging system. Such imaging systems are affected by image distortions and displacements that degrade the precision with which a line of sight and other selection can be made from an image presented to the user. Therefore, there exists a need for a 3D scanner that provides undistorted images, that are correctly aligned with the coordinate system of the scanner, as a precise visual interface for an interactive setup of scanning parameters. The present invention addresses this need.

In an imaging system, optical information is commonly projected from a 3D scene via a lens system onto a 2D area-array sensor. The array sensor transforms the optical information into electronic information that is computationally processed for presenting on a screen or other well-known output devices. Area-array sensors have a number of pixels each of which captures a certain area of the projected scene. The number of pixels determines the resolution of the area-array sensor. Unfortunately, area array sensors are expensive to fabricate. Especially in a 3D scanner where the imaging system performs the secondary operation of providing the user with image information, the preferred choice are less expensive area-array sensor with low resolution. However, it is desirable to present an image with high resolution to the user in order to make precise selections. Also, in cases where the 2D image may be combined with the 3D information to provide texture mapping on the scanned object, a higher resolution than that obtainable with reasonably affordable area-array sensor may be required. This has been demonstrated in the prior art by introducing a boresighted camera that takes image mosaics which may be assembled into a larger image. Unfortunately, the image distortion of the image mosaics makes a seamless assembly difficult to accomplish. Therefore, there exists a need for a method and apparatus that provides in combination with a 3D scanner an undistorted image seamlessly assembled from a number of undistorted image mosaics. The present invention addresses this need.

Combining a 3D laser scanner with a 2D imaging system requires filter techniques that are capable of distinguishing between the scene and laser point in the scene. The prior art teaches methods for isolation of a pulsed illumination event from background information in camera images (for example, Talmi et al, U.S. Pat. No. 5,821,547; Kamasz et al, U.S. Pat. No. 5,585,652). The techniques are based on acquiring two short exposure images: the first image is synchronized with the pulsed illumination, and the second image is timed to occur only when ambient light is illuminating the scene. The exposure time for both images is the same, and needs to be just long enough to include the length of the illumination pulse. Subsequent comparison (subtraction) of the two images will remove the background illumination that is common to the two images, and leave only the illumination due to the pulsed light source. In a field scanning device where a scanning range may be up to dozens of meters, the laser point becomes only a portion of the pixel size in the scenery projected onto the 2D area-array sensor. A detection of the laser point for the purpose of lens system calibration or determining image locations to subpixel accuracy may become impossible for a given pixel size. Thus, in order to facilitate laser measurements for correction of image distortion, there exists a need for a method to make laser points visible in a scenery projected onto a 2D area-array sensor. The present invention addresses also this need.

Advantages of the subject invention may be summarized as follows;

a. No precision calibration object is required;

b. Measurement of calibration control points is provided by the integrated precision motion and ranging device present in the apparatus for the operational 3D scanning;

c. Simple centroid algorithms provide precise sub pixel locations of the object point illuminated by the laser pulses arrayed in conjunction with the available pixel resolution;

d. Calibration of a large-volume field of view is achieved by acquiring control point data from objects distributed throughout the desired field of view;

e. Each time new lens settings are used, new calibration control points can be readily acquired from objects within the desired field of view. Time-consuming placement and measurement of a calibration object at multiple locations in the field of view (FOV) is not required.

f. The recalibration process can be entirely automated;

g. In a 3D scanner where an imaging system is already present, the invention may be implemented by applying a special computer program.

### SUMMARY

In the preferred embodiment, a 3D scanner or integral precision laser ranging device is utilized to provide calibration information for determining the imaging model of a digital imaging system. The imaging model includes the geometrical transformation from 3D object space to 2D image space, and a distortion map from object to image space. As a result, an undistorted image may be presented to a user as an interface for precisely defining a scanning area for a consecutive scanning operation performed by the laser ranging device. The camera model may be used to transform user-selected image coordinates to an angular laser trajectory direction in the scanner 3D coordinate system. Additionally, the model may be used to map color image information onto measured 3D locations.

When a laser beam has been directed to a surface that is within the camera's field of view, a small luminescent spot appears where the laser beam, strikes the sample. At the same time, the laser ranging device recognizes the distance to the spot, which is mathematically combined with the spatial orientation of the laser beam to provide a scene location of that spot. For the purposes of this application, the illuminated spot on the object surface will be called the laser spot (LT). The spatial direction and orientation of the laser beam can be controlled by a well known galvanometer mirror unit that includes two controlled pivoting mirrors that reflect the laser beam and direct it in a predetermined fashion.

The luminescent spot is captured in a first image taken with the camera. To filter background information from the first image, a second image is taken with identical lens setup as the first image, and close in time to the first image, while the laser is turned off. The second picture is computationally subtracted from the first image. The result is a spot image that contains essentially only the luminescent spot. The spot image is affected by the lens characteristics such that the luminescent spot appears at a distorted location within the image.

The lens imaging model may consist of a number of arithmetic parameters that must be estimated by mathematical methods to a high degree of precision. The precision model may then be used to accurately predict the imaging properties of the lens system. To derive model information for the entire field of view or for the framed image, a number of spot images are taken with spot locations varying over the entire FOV or framed image. The firing period of the laser may thereby be optimized in conjunction with the exposure time of the image such that a number of luminescent spots are provided in a single spot image. The goal of such optimization is to derive lens model information for the entire image with a minimal number of images taken from the scene.

The number of necessary spot images depends on the number of model parameters that are to be estimated and the precision with which the model is to be applied for image correction, color mapping, and laser targeting. The model parameters (described in detail below) include the origin of the camera coordinate system, rotation and translation between the scanner and camera coordinate systems, lens focal length, aspect ratio, image center, and distortion. Types of distortion induced by the lens system that are substantial in conjunction with the scope of the present invention are radial symmetric distortions as illustrated in FIGS. 1a, 1b, as well as arbitrary distortion as illustrated in FIG. 1c. The radially symmetric distortions have a relatively high degree of uniformity such that only a relatively small number of spot images are necessary to process the correction parameters for the entire image. On the other hand, arbitrary distortions resulting, for example, from off center position of individual lenses within the lens system, have a low degree of uniformity necessitating a larger number of spot images for a given correction precision. The correction precision is dependent on the image resolution and the image application. In the preferred embodiment, where the image model is primarily utilized to create an image-based selection interface for the consecutive scanning operation, the correction precision is adjusted to the pixel resolution of the displayed image.

The lens imaging model information contained in the set of spot images and the 3D locations of the corresponding object points is extracted in two steps. First, the initial estimate of the model of the transformation from 3D object to 2D image coordinates is determined using a linear least squares estimator technique, known as the Direct Linear Transform (DLT). The second step utilizes a nonlinear optimization method to refine the model parameters and to estimate the radial and tangential distortion parameters. The nonlinear estimation is based on minimizing the error between the image location computed by the lens imaging model utilizing the 3D spot locations, and the image location determined by the optical projections of the laser spot.

The subject invention is particularly useful in conjunction with a laser scanning device configured to generate 3D images of a target. In these devices, the diameter of the laser spot is relatively small to provide high resolution measurements. As a result, it is often difficult to accurately image the location of the laser spots on a conventional 2D area-array sensor. In order to overcome this problem, the detection of the laser on the array can be enhanced by generated a small array of spots which can be more easily detected by the array. The spot array may be configured such that a number of adjacent pixels may recognize at least a fraction of the spot array resulting in varying brightness information provided by adjacent pixels. The individual brightness information may be computationally weighted against each other to define center information of the spot array within the spot image. The center information may have an accuracy that is higher than the pixel resolution of the sensor.

For computationally projecting the scene location of a laser spot onto the spot image, the model of the lens system is considered. In a fixed lens system where the field of view is constant, the model is also constant. In contrast, in a variable lens system, the user may define the field of view resulting in a variable lens model. In the case where the focal length of the lens is changed in order to effect a change in the FOV of the lens system, a number of camera model parameters may also change. In order to avoid the complete recalibration of the lens system, the present invention allows the monitoring of the camera model parameters as the FOV is changed. A small number of illuminated spots may be generated in the scene. As the lens is zoomed, the spots are used to continually update the model parameters by only allowing small changes in the parameter values during an optimization. Thus, no lens settings need to be monitored, whether a fixed lens system or a variable lens system is used.

In alternate embodiments, a scenery image may be provided with a resolution that is independent of the pixel resolution of the area-array sensor. In this manner, the complete scenery image may be composed of a number of image miniatures assembled like a mosaic. For that purpose, a narrow view camera is introduced that is focused on the scenery via the mirror unit and operated in conjunction with the mirror unit to sequentially take image mosaics of the relevant scenery. The teachings in the paragraphs above apply also for the narrow field of view camera except for the following facts. Firstly, since the narrow field of view can be independently defined for the relevant scenery, it can be optimized for spot recognition and/or for distortion correction. For example, the narrow field of view may be fixed with a focus length and a corresponding magnification such that a single laser spot is recognized by at least one sensor pixel.

Directing the camera's narrow field of view through the mirror unit allows the orientation of the field of view to be controlled with a fixed apparatus. In the case where the ranging laser is directed through the same mirror unit, the angular spot orientation is fixed relative to the narrow field of view. Thus, only a single illuminated spot is available for generating a distortion map. In this case, an additional optical element may be used to shift the FOV of the narrow FOV camera relative to the scanned laser beam. The additional optical element need only shift the camera FOV within +/− one half of the total field of view relative to its nominal optical axis. The additional optical element may consist of an optical wedge, inserted between the narrow FOV camera 42 and the beam combiner 15 (FIG. 12), that can be rotated to deflect the optical axis. Since the narrow FOV camera has relatively low distortion, a reduced number of laser spots may be sufficient to estimate the model parameters with high precision. In an alternate embodiment, the optical element is used to induce a relative movement onto the laser beam while the scanning mirrors remain stationary. Since the narrow field of view camera is not configured to generate an image from the entire scene, a second, wide field of view camera may be integrated in the scanner, which may have a fixed or a variable lens system. In case of a variable lens system for the wide field of view camera and a fixed lens system for the narrow field of view camera the number of miniatures taken by the narrow field of view camera may be adjusted to the user defined field of view.

### BRIEF DESCRIPTION OF THE FIGURES

FIGS. 1a, 1b show the effect of radially symmetric distortions of an image projected via a lens system.

FIG. 1c shows the effect of arbitrary distortions of an image projected via a lens system.

FIG. 1d shows a two dimensional graph of radial symmetric distortion modeled as a function of the distance to image center.

FIG. 2 illustrates schematically the operational principle of a prior art 3D scanner.

FIG. 3 shows the scanning area of the 3D scanner of FIG. 2.

FIG. 4 shows a radially distorted image of the scanning area of FIG. 2.

FIG. 5 shows a distortion corrected image of the scanning area of FIG. 2. The corrected image is in accordance with an object of the present invention utilized to precisely define a scanning area for the 3D scanner of FIG. 2.

FIG. 6 schematically illustrates the internal configuration of the 3D scanner of FIG. 2 having a wide field of view camera with a fixed lens system.

FIG. 7 shows a first improved 3D scanner having an image interface for selecting the scanning area from an undistorted image.

FIG. 8 shows a second improved 3D scanner having an image interface for selecting the scanning area from an undistorted image and a variable lens system for adjusting the field of view.

FIG. 9 shows a third improved 3D scanner having an image interface for selecting the scanning area from an undistorted image with an image assembled from image mosaics taken with a second narrow field camera. First and second camera have fixed lens systems.

FIG. 10 shows a fourth improved 3D scanner having an image interface for selecting the scanning area from an undistorted assembled image provided from a selected area of a setup image taken by the first camera. The first camera has a fixed lens system and the second camera has a variable lens system.

FIG. 11 shows a fifth improved 3D scanner having an image interface for selecting the scanning area from an undistorted and adjusted image. The first and the second camera have a variable lens system.

FIG. 12 shows a configuration of the 3D scanners of FIG. 9, 10, 11 having an additional optical element for providing a relative movement between the second camera's view field and the laser beam.

FIG. 13 illustrates a method for generating a spot image containing a single image spot.

FIG. 14 shows the geometric relation between a single projected spot and the 2D area-array sensor.

FIG. 15 shows the geometric relation between a projected spot cluster and the 2D area-array sensor.

FIG. 16 illustrates a method for generating a spot image containing a single imaged spot cluster.

FIG. 17a illustrates a distortion vector resulting from a reference spot and an imaged spot.

FIG. 17b illustrates a distortion vector resulting from a reference cluster and an imaged spot cluster.

FIG. 18 schematically illustrates the process for generating a distortion map by a processor.

FIG. 19 shows an array of calibration control spots for correction arbitrary and/or unknown image distortions.

FIG. 20 shows a radial array of calibration control spots for correcting radial distortions with unknown distortion curve and unknown magnification of the lens system.

FIG. 21 shows a method for quasi-real time image correction where the lens settings do not have to be monitored.

### DETAILED DESCRIPTION

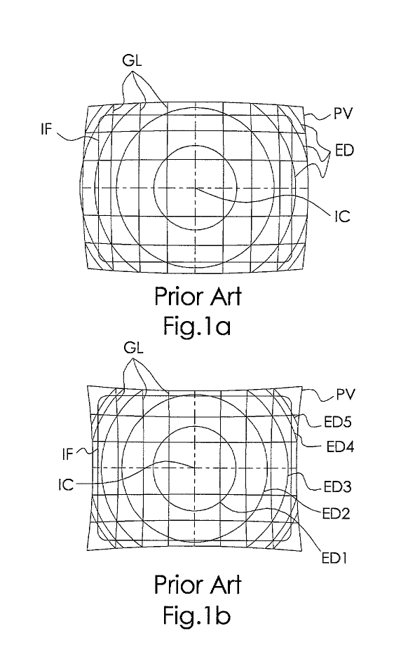

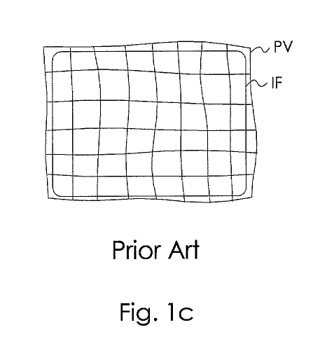

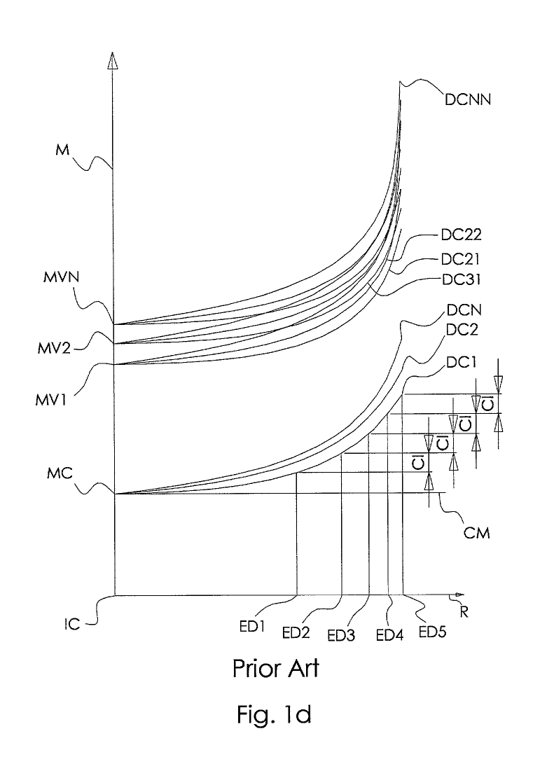

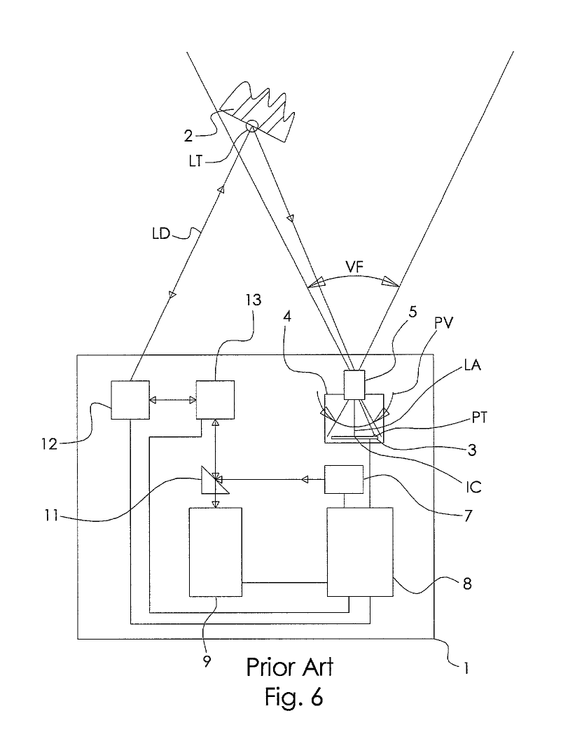

There exist a number of image distortions introduced by lens systems. The most common are radially symmetric distortions as illustrated in FIGS. 1a, 1b and arbitrary distortions as illustrated in FIG. 1c. Referring to FIGS. 1a and 1b, a view PV projected on an image frame IF via a lens system 5 (see FIG. 6) may experience thereby either a barrel distortion (see FIG. 1a) or a pincushion distortion (see FIG. 1b). The nature of radial distortion is that the magnification of the image changes as a function of the distance to the image center IC, which results in straight gridlines GL being eventually projected as curves by the lens system 5. With increasing distance to image center IC, the radius of the projected grid lines GL becomes smaller.

In a radially distorted image, concentric image areas have the same magnification distortions as illustrated by the equal distortion circles ED1-ED5. Image areas in close proximity to the image center IC are essentially distortion free. Peripheral image areas like, for example, the corner regions of the image, have maximum distortion. In barrel distortion, the magnification decreases towards the image periphery. In pincushion distortion, magnification increases towards the image periphery. Radial symmetric distortions are the most common form of distortions induced by lens systems. In variable lens systems also called zoom lenses, radial distortion is practically unavoidable. Also in fixed lens systems, radial distortion become increasingly dominant the more the focus length of the lens system is reduced. Besides radial distortion, there exist other forms of image distortions, which are mainly related to fabrication precision of the lenses and the lens assembly. These distortions are generally illustrated in FIG. 1c as arbitrary distortions.

Rotationally symmetric distortions can be modeled for an entire image in a two dimensional graph as is exemplarily illustrated in FIG. 1d. The vertical axis represents magnification M and the horizontal axis distance R to the image center IC. Distortion curves DC1-DCNN for the entire image may be modeled as functions of the distance to the image center IC. The distortion curves DC1-DCNN start essentially horizontally at the image center IC indicating a constant magnification there. The further the distortion curves DC are away from image center IC, the steeper they become. This corresponds to the increasing change of magnification towards the image periphery.

The exemplary distortion curves DC1-DCNN correspond to a pincushion distortion as shown in FIG. 1b. For the purpose of general understanding, the equal distortion circles ED1-ED5 are shown with a constant increment CI for the distortion curve DC1. In case of barrel distortion, the distortion curves would increasingly decline in direction away from the image center IC. In an undistorted image UI (see FIG. 5), the magnification would be constant in radial direction. This is illustrated in FIG. 1d by the line CM. One objective of the present invention is to model the distortion curves without the need for monitoring the setting of the lens system.

Lens systems may be calibrated such that their distortion behavior is known for a given magnification, varying aperture and focus length. For a fixed lens system, the distortion behavior may be characterized with a number of distortion curves DC1-DCN that share a common magnification origin MC, since a fixed lens system has a constant magnification. The distortion curves DC1-DCN represent various distortions dependent on how aperture and focus length are set. Due to the relatively simple distortion behavior of fixed lens system a number of well-known calibration techniques exist for accurately modeling the distortion curves from observed aperture and focus parameters.

The distortion behavior of a variable lens system is more complex since the magnification varies as well, as is illustrated by the varying magnifications MV1-MVN in FIG. 1d. Whereas in a fixed lens system, only aperture and focus length vary and need to be considered for modeling the distortion curves, in a variable lens system magnification has to be considered as well. The result are overlapping distortion curves DC21-DCNN. Modeling distortion curves for variable lens systems is a much more complex task and requires the observation of the magnification as well. Feasible calibration techniques for variable lens systems perform interpolation between measured sets of distortion curves that are correlated to the monitored lens parameters.

To automatically observe lens parameters, lens systems need sensors, which make them relatively complex and expensive. An advantage of the present invention is that no lens parameters need to be monitored for modeling the distortion curves DC1-DCNN. This allows for simple and inexpensive lens systems to be utilized for an undistorted imaging.

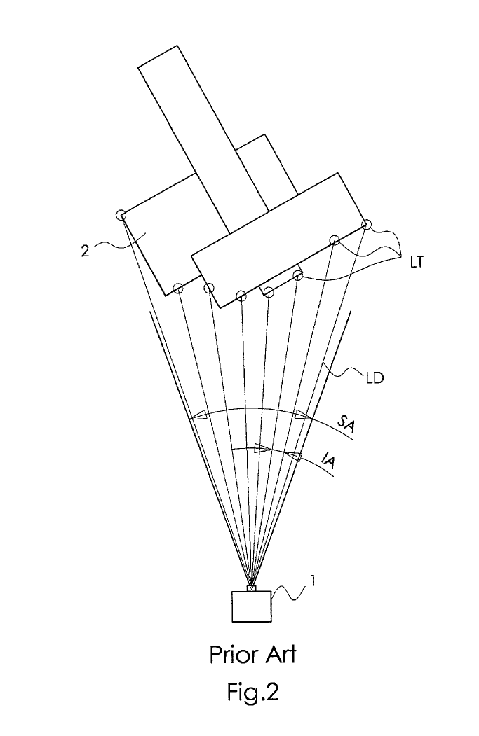

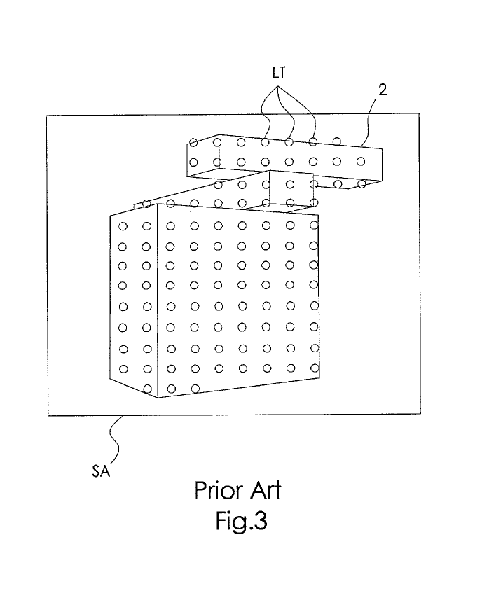

There are imaging systems where image distortion is an important factor of the systems functionality. Such an imaging system may, for example, be integrated in a prior art 3D scanner 1 as is shown in FIG. 2. To scan an object 2, the 3D scanner 1 is set up a certain distance to the object 2, such that a scanning area SA covers the object 2. Laser pulses are fired along the laser trajectories LD such that they impinge somewhere at the object's surface causing an illuminated laser spot LT. The laser trajectories LD are spatially offset to each other. The offset SG influences the resolution with which the scan is performed. FIG. 3 shows the object 2 as seen from the scanner's 1 point of view.

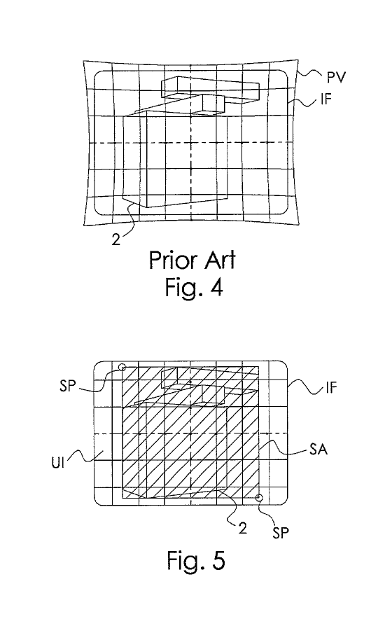

To monitor the setup process of the 3D scanner, an imaging system may be integrated in the 3D scanner 1. Referring to FIG. 6, the view field VF of the scanner's 1 camera 4 may correspond to the scanning area SA. As seen in FIG. 4, the optically generated image can be affected by the distortions induced by the camera's lens system 5. A distorted image of the scanning area SA displays the object 2 inaccurately.

As is illustrated in FIG. 5, the present invention provides an undistorted image UI within which the user may select the scanning area SA with high precision. Image coordinates SP selected by the user are computationally converted into a line of sight for the laser scanner 1. The undistorted image UI may further be utilized for texture mapping where visual information of the object 2 can by applied to the scanned 3D geometry of the object 2. As one result, color codes of the object 2 may be utilized to identify individual components of the object 2. Where the scanned object 2 has a high number of geometrically similar features like, for example, pipes of an industrial refinery, highly accurate texture mapping becomes an invaluable tool in the scanning process.

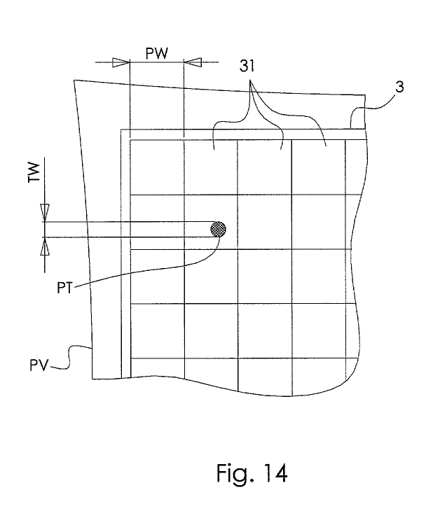

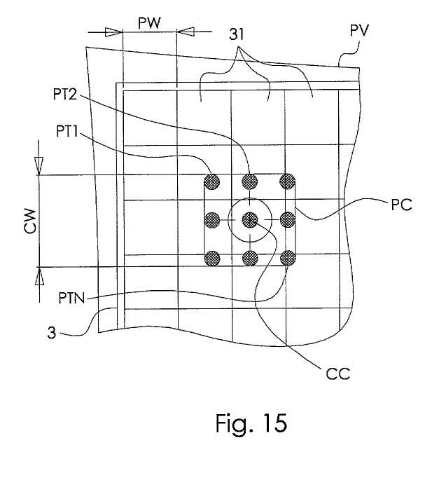

FIG. 6 shows a conventional 3D scanner 1 having a wide field of view (WVF) camera 4 within which a view field VF is optically projected onto a well known 2D area-array sensor 3. The sensor 3 has a number of light sensitive pixels 31 (see also FIGS. 14, 15), which are two dimensionally arrayed within the sensor 3. Each pixel 31 converts a segment of the projected view PV into an averaged electronic information about brightness and eventually color of the projected view segment that falls onto that pixel 31. Hence, the smaller the pixels 31, the smaller are individually recognized features.

The lens system 5 in this prior art scanner 1 may have a fixed lens system 5 that provides the projected view PV with a constant magnification MC from the view field VF. The lens system 5 may have a lens axis LA that corresponds to the image center IC of the projected view PV. The sensor 3 converts the projected view into an electronic image forwarded to a processor 8. The processor 8 also controls and actuates a laser 7, the moveable mirrors 12, 13 and the receiver 9. During the scanning operation, the processor 8 initiates a number of laser pulses to be fired by the laser 7. The laser pulses are reflected by the beam splitter 11 and are spatially directed onto the scene by the controlled mirrors 12, 13. The laser spot LT appears on the object 2 for a short period. The illuminated spot LT sends light back to the scanner, which propagates through the mirrors 12, 13 towards the beam splitter 11, where it is directed towards the receiver 9. The processor calculates the time of flight of the laser pulse or triangulates the distance to the laser spot on the object. The spatial orientation of the laser trajectory LD is recognized by the processor 8 as a function of the mirrors' 12, 13 orientation. In combination with the information provided by the receiver 9 the processor 8 computationally determines the 3D location of the laser spot LT relative to the scanner's 1 position and orientation.

An image, taken by the camera 4 during a laser firing, contains a spot image PT projected via the lens system 5 from the illuminated spot LT onto the sensor 3. The present invention utilizes this fact to determine the image distortion at the image location of the laser spot LT. This is accomplished by electronically comparing the calculated scene location of the laser spot LT with the image location of the spot image PT. This is accomplished by applying an algorithm to computationally project the laser spot LT on the image and compare it with the image location of the spot image PT Information about the image distortion at the image location of the spot image PT is derived by comparing the image coordinates of the computationally projected laser spot LT with the image coordinates of the spot image PT.

Hardware Embodiments

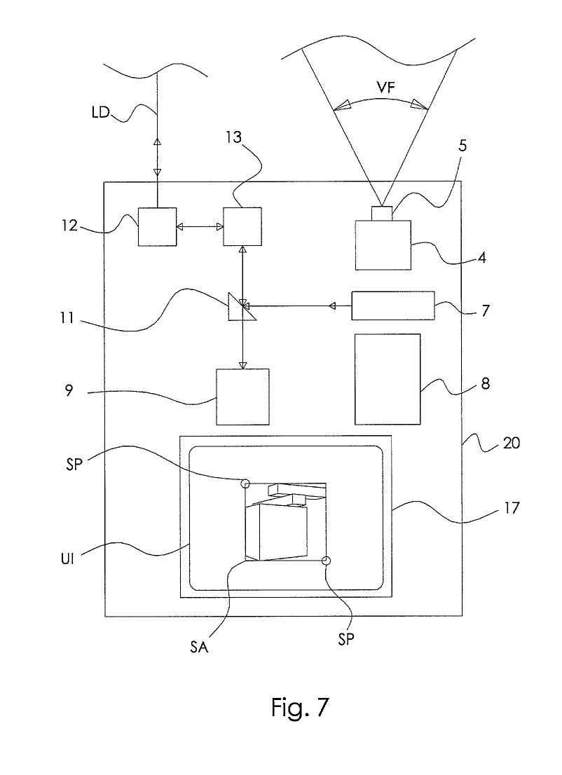

Examples of certain laser scanner and imaging systems which would benefit from the method of subject invention are schematically illustrated in FIGS. 7-10. Referring first to FIG. 7, the first embodiment includes an image interface 17 capable of recognizing selection points SP set by a user. The selection points SP are processed by the processor 8 to define the scanning area SA. Since an undistorted image UI is presented on the image interface 17, the scanning area SA can be selected with high precision. The image coordinates of the selection points SP are calculated by the processor into boundary ranges of the mirrors 12, 13.

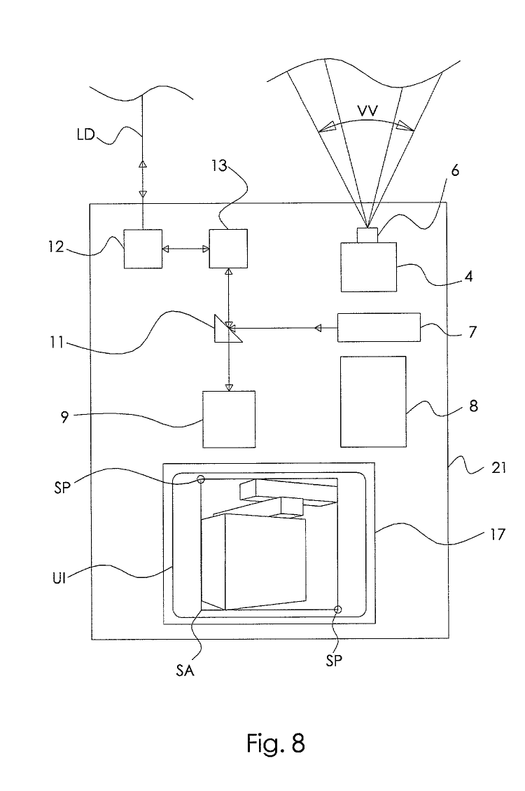

Referring to FIG. 8, a variable lens system 6 is utilized in the camera 4 rather than a fixed lens system 5. A variable view field VV may be defined by the user in correspondence with a size of the intended scanning area SA. The adjusted magnification MV allows a more precise definition of the scanning area SA.

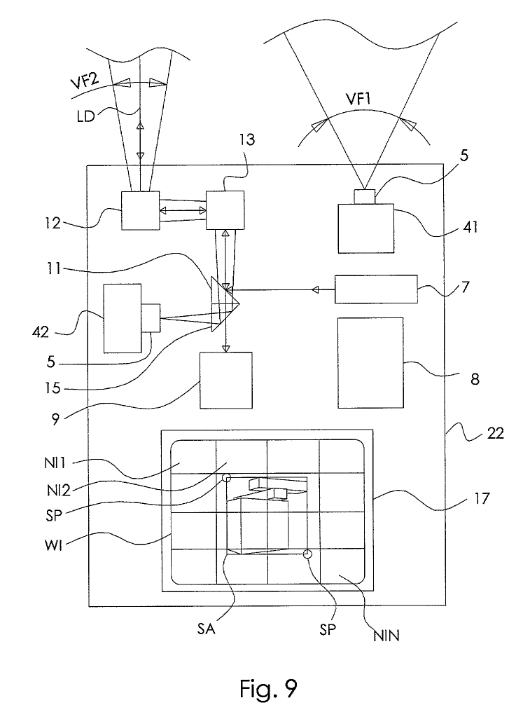

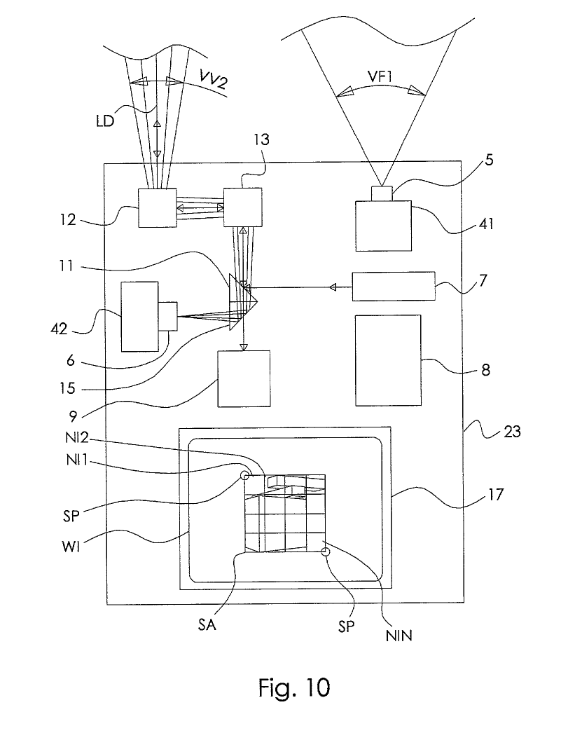

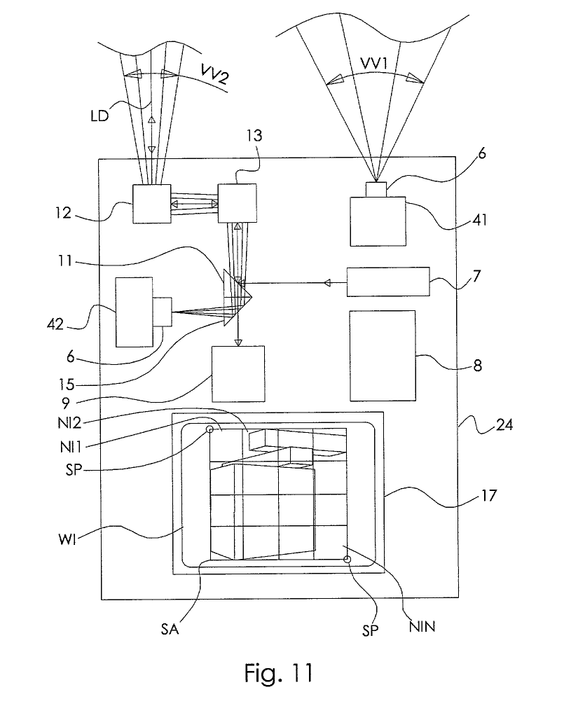

Referring to FIG. 9, a 3D scanner 22 features a wide field of view camera 41 and a narrow field of view camera 42. Both cameras 41, 42 have a fixed lens system 5 and a sensor. The introduction of the camera 42 allows displaying an image on the image interface 17 with a resolution that is independent from the resolution provided by the sensor 3 of the camera 41. The increased image resolution additionally enhances selection precision. The camera 41 is optional and may be utilized solely during setup of the 3D scanner. A setup image may be initially presented to the user on the image interface 17 generated only with the camera 41. The setup image may be corrected or not since it is not used for the scan selection function. Once the 3D scanner 22 is setup, the camera 41 is turned off and the camera 42 turned on. In consecutive imaging steps that are synchronized with the mirrors 12, 13 images are taken from the scene in a mosaic like fashion. Image correction may be computed from the processor 8 for each individual mosaic NI1-NIN such that they can be seamlessly fit together. The present invention is particular useful in such embodiment of the 3D scanner 22 (and scanners 23, 24 of FIGS. 10, 11) since only undistorted images can be seamlessly fit together.

The field of view of the narrow field camera 42 may be defined in correspondence with the pixel resolution of its sensor and the spot width TW (see FIG. 14) such that at least one pixel 31 (see FIG. 14) of the camera's 42 sensor recognizes a spot image PT.

FIG. 10 shows another embodiment of the invention for an improved 3D scanner 23 having the camera 41 with a fixed lens system 5 and the camera 42 with a variable lens system 6. The 3D scanner 23 may be operated similarly as the scanner 22 of FIG. 9 with some improvements. Since the camera 42 has a variable magnification MV, it can be adjusted to provide a varying image resolution. This is particular useful when the setup image is also utilized for an initial view field selection. In that case, the user may select a view field within the setup image. The selected view field may be taken by the processor 8 to adjust magnification of the camera 42 in conjunction with a user defined desired image resolution or distortion precision. After the mosaics NI1-NIN are assembled, the high-resolution image may be presented in a manner similar to that described with reference to FIG. 8. In a following step, the scanning area SA may be selected by the user from the high-resolution image.

FIG. 11 shows an advanced embodiment with a 3D scanner 24 having variable lens systems 6 for both cameras 41, 42. Both view fields VV1, VV2 may be thereby adjusted with respect to each other and for optimized display on the interface 17.

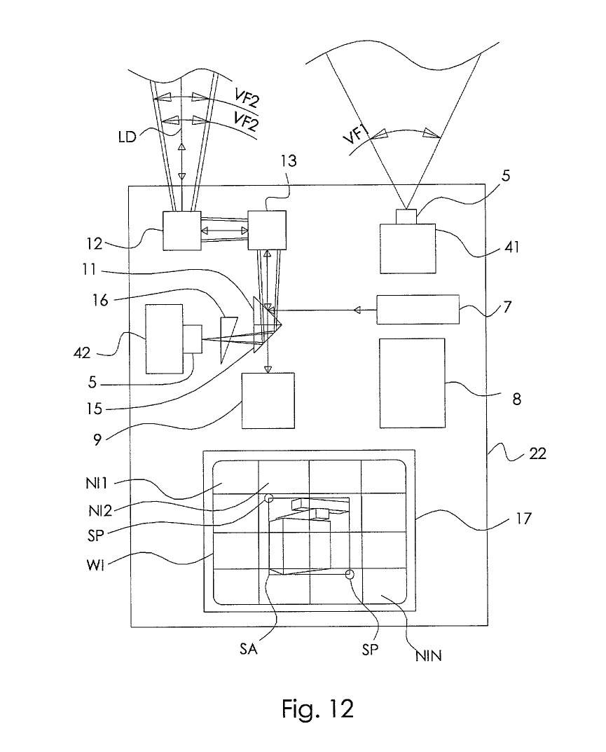

The embodiments described with reference to FIGS. 9, 10 and 11 may require an additional optical element to permit calibration of the narrow field of view camera 42. More specifically, and as shown in FIG. 12, since the view field of the camera 42 is boresighted (i.e. directed together with the laser beam by mirrors 12,13) an optical element 16 may be placed directly before the camera 42 to provide relative movement between the camera's 42 view field VF2 and the laser beam.

In a first case, where it is desirable to keep optical distortion along the laser trajectory to a minimum, optical element 16 may be placed along the optical axis of the camera 42 at a location where both the outgoing laser beam and the incoming reflected laser beam remain unaffected. Such a location may for example be between the camera 42 and the beam combiner 15. The optical element 16 may for example be an optical wedge, which may be rotated and/or transversally moved. As a result, the view field VF2 may be moved in two dimensions relative to the laser trajectory LD. The relative movement of the view field VF2 may be again compensated by the mirrors 12, 13, such that during the calibration process, the camera 42 captures the same background image while the laser spot LT is moved by the mirrors 12, 13. This compensation is necessary and implemented mainly in cases where multiple laser spots LT are captured on a single spot image TI. Exact mirror compensation requires a highly precise motion control of the mirrors 12, 13 to avoid background artifacts in the spot image TI. In a second case, the optical element 16 may be alternatively placed along the laser beam trajectory LD right after the laser 7 and before the beam splitter 11. In that case, the relative movement is directly induced onto the laser beam such that the mirrors 12, 13 remain immobile during the calibration process of the camera 42.

The camera 42 may further be utilized for texture mapping where graphic information of the scene is captured and used in combination with the scanned 3D topography. This is particularly useful in cases of reversed engineering, where color coded features need to be automatically recognized. The use of a variable lens system 6 for the narrow field of view camera 42 may be utilized thereby to provide image resolution required for graphical feature recognition.

Method of Isolating the Laser Pulse Spot from Background Illumination

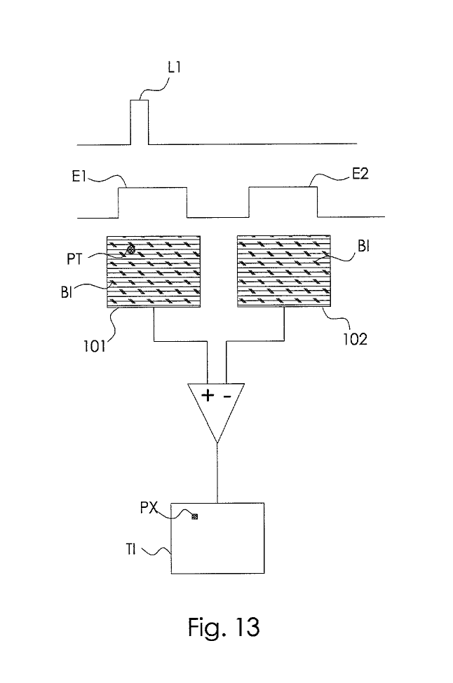

In order to accurately identify the location of a laser spot on a target, background illumination needs to be filtered out from the image containing the spot image PT. FIG. 13 schematically illustrates this process.

In this process, the laser spot LT is captured by the camera 4 from the scenery by overlapping the exposure period E1 of the camera 4 with a firing period L1 of the laser 7. This generates a first image 101 that contains the spot image PT and background information BI. While the laser is turned off, a second image 102 is generated with same settings as the first image 101. Since no laser firing occurs during the exposure period E2 of the second image 102, no laser spot LT is imaged. Both images projected onto the sensor 3 are converted by the sensor 3 into an electronic form and the background information from the first image 101 is simply removed by computationally comparing the pixel information of each of the images 101 and 102 and clearing from the first image 101 all pixel information that is essentially equal to that of the second image 102. The result is an image TI that contains solely pixel information PX of the spot image PT. In order to keep background discrepancies of first and second image 101, 102 to a minimum, the exposure periods E1 and E2 are as close as feasible.

Use of Spot Clusters to Enhance Laser Spot Detection

As seen in FIG. 14, a laser spot PT imaged onto the detector array may be significantly smaller than the size of a pixel. This is shown by the spot image PT having spot width TW and the pixel 31 having a pixel width PW. Since the pixel output is merely an average of the total brightness of the light falling on that pixel, accurate location within the pixel is not possible. Moreover, even when using background subtraction as described above, the intensity of the spot may be too low to be recognized by the pixel. This can be common in a field scanner application, where variations in scene illumination caused by variations in the reflective properties of the scanned surfaces and atmospheric conditions may degrade the contrast with which the laser spot LT is projected onto the sensor 3.

To make the optical recognition less dependent upon the size and contrast of the spot image, the laser can be programmed to fire a sequence of tightly spaced spots on the target. These spots would be imaged on the array in the form of a spot cluster TC (see spots LT1-LTN of FIG. 15) A center finding algorithm can then be used to identify the center of the cluster with a precision that is higher than the pixel resolution of the sensor 3. The size and number of spots in the cluster are selected to best achieve this goal in the shortest amount of time. A similar result can be achieved using a continuous wave (or CW) laser moved by the mirrors 12, 13 to generate during the exposure period E1 an illuminated line within predefined boundaries of the cluster TC. As a result, a continuous line rather than a number of spots may be imaged by the sensor 3 during the exposure period E1. The uninterrupted laser firing allows to induce a higher illumination within the cluster boundary, which may additionally assist in obtaining more contrast between the spot cluster TC and background information.

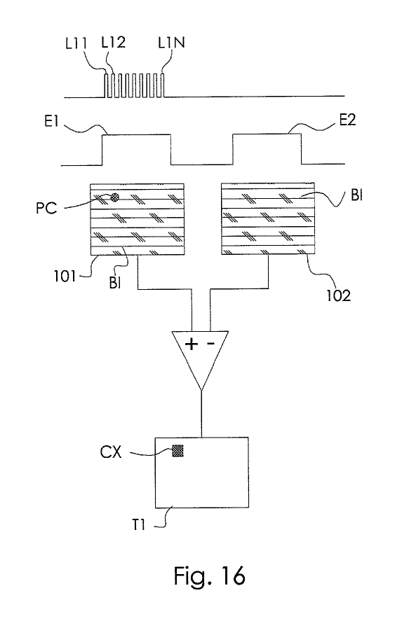

FIG. 16 illustrates the method by which a spot image TI of the cluster image PC is generated. The main procedure is similar to that explained under FIG. 13 with the exception that multiple laser firings L11-L1N or a continuous laser firing occur during the first exposure time E1. The processor 8 actuates the mirrors 12, 13, the laser 7 and eventually the optical element 16 to provide for a number of laser spots LT1-LTN or for an illuminated line at distinct scene locations in conjunction with the predetermined configuration of the cluster image TC and the magnification of the lens system. A laser fired with a rate of 2500 pulses per second results in an average firing interval of 0.0004 seconds. For an exemplary exposure time E1 of 0.032 seconds, 9 laser pulses L11-L1N can be generated. The elapsed time for the laser firings is about 1/9^{th} of the exposure time E1, which leaves sufficient time to adjust for the various degrading influences with an increased number of laser firings up to the continuous laser firing. Even more, a number of spot clusters TC may be imaged during a single exposure time E1.

Computing Distortion Vectors

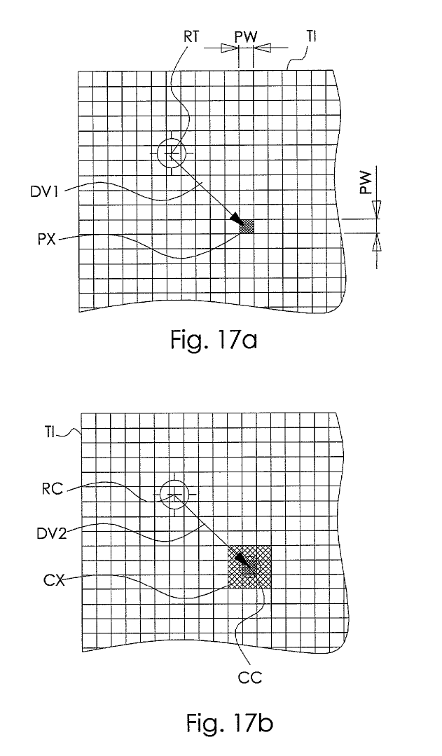

FIG. 17a illustrates the simple case, where a single spot image PT is captured by one of the sensor's 3 pixel 31 (see FIG. 14) and present in the spot image TI as the spot pixel PX having an image coordinate range defined by the pixel width PW. The optically generated spot image PT is thereby converted into an electronic signal representing the spot pixel PX, which is further computationally utilized within the processor 8. The image coordinate range of the spot pixel PX may be computationally compared to the image coordinates of the computationally projected spot RT. The computed spot RT has a coordinate range that is defined by the accuracy of the mirrors 12, 13 and the precision of the laser 7 and is not affected by tolerances applicable to the spot pixel PX. The computed spot RT represents a reference point to determine the amount and direction of the distortion induced to the spot pixel PX at its image coordinate. The result is a first distortion vector DV1, which carries information of amount and orientation of the image distortion at the image coordinate of the spot pixel PX. The precision of the first distortion vector DV1 corresponds to the image coordinate range of the spot pixel PX. To correct the distortion of the spot pixel PX, the distortion vector DV1 may be applied to the spot pixel PX in opposite direction.

FIG. 17b illustrates the more complex case, where the spot cluster TC is utilized. In this embodiment, the cluster image PC is converted into a pixel cluster CX in the same fashion as the spot pixel PX from the spot image PT. A centroid finding algorithm is applied to the pixel cluster CX in order to define a precise coordinate information for the cluster center CC. The algorithm takes the brightness information of all pixels of the pixel cluster CX and weights them against each other. For example, the cluster image PC may have a width CW and a number of projected traces PT1-PTN with a certain brightness at the sensor 3 such that between four and nine pixels 31 recognize brightness of the spot cluster TC. A number of centroid or moment algorithms are known in the art that typically provide accurate results when the distribution of light on the sensor covers 2 to 3 pixels in one dimension resulting in a range of 4 to 9 pixels documenting the pixel cluster CX.

A 6 mm diameter laser spot at 50 m subtends about 0.007 deg (atan(0.006/50)*1 80/PI). In a 480×480 pixel image of a 40 deg FOV, each pixel subtends 0.083 deg, so that the image of the spot is less than 1/10^{th} of the size of a pixel. To improve the performance of the centroid algorithm in the preferred embodiment, a sequence of 9 images are accumulated while the angle of the laser beam is incremented in azimuth and elevation such that a 3×3 pattern of pixels are illuminated with an angular trajectory increment of 0.083 deg. The centroid is calculated from the pixels 31 of the imaged cluster IC to provide the location of the cluster center CC with subpixel accuracy.

In the following, an exemplary mathematical solution for finding the cluster center CC within the spot image TI is presented. First, the brightest pixel is determined in the image TI, and then the center of gravity or centroid of the pixel intensities in the neighboring region of the brightest pixel are calculated. In one embodiment of the invention, an algorithm based upon the moments of area may be used to determine the spot centroid to sub-pixel precision. If f (xₗ, yₘ) is the two-dimensional normalized distribution of intensities in the image region surrounding the brightest pixel, the jk^{th} moments are defined as:

$${M}_{j k} = {\sum }_{l = 1}^{n} {\sum }_{m = 1}^{n} {( {x}_{l} )}^{j} {( {y}_{m} )}^{k} f ( {x}_{l} , {y}_{m} ) \\ fo r j , k = 0 , 1 , 2 , 3 … \qquad [ 1 ]$$

The x and y coordinates of the center-of-gravity or centroid of the pattern of pixel intensities are given by

$$\overline{x} = \frac{{M}_{10}}{{M}_{00}} a n d \overline{y} = \frac{{M}_{01}}{{M}_{00}} . \qquad [ 2 ]$$

The standard deviation of the pattern of pixel intensities in the x and y axis directions are computed with respect to the center of gravity as

$${σ}_{x} = \sqrt{\frac{{\overline{M}}_{20}}{{M}_{00}}} a n d {σ}_{y} = \sqrt{\frac{{\overline{M}}_{02}}{{M}_{00}}} , \\ w h e r e {\overline{M}}_{20} = {M}_{20} - \frac{{M}_{10}^{2}}{{M}_{00}} a n d {\overline{M}}_{02} = {M}_{02} - \frac{{M}_{01}^{2}}{{M}_{00}} . \qquad [ 3 ]$$

The second distortion vector DV2 is generated by computationally comparing the image coordinates of the cluster center CC to the image coordinates of the reference cluster RC. The image coordinates of the reference cluster RC are provided in similar fashion as the reference spot RT explained under FIG. 17a except that a center RC of the spot cluster TC is computed by the processor 8 from the coordinates of the individual traces LT1-LTN. Due to the increased precision of the cluster center CC, the second distortion vector DV2 has a higher precision than the first distortion vector DV1 and can be tuned by adjusting the configuration of the spot cluster TC. The precision of the second distortion vector DV2 may be adjusted to the fashion by which the lens system is modeled and the distortion map generated as is explained in the below.

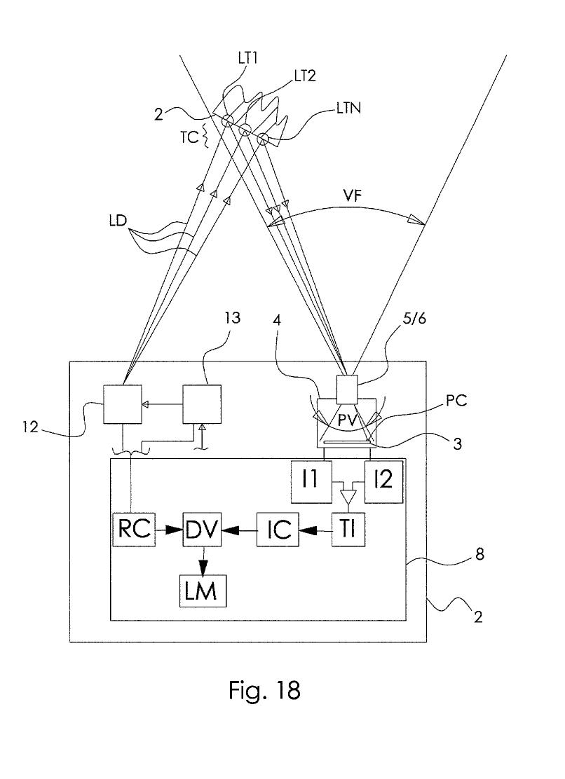

The lens system is modeled and the distortion map is generated by applying the steps illustrated in FIGS. 13 and/or FIG. 16 to the entire image in a fashion that is dependent on the type of image distortion to be corrected. A number of distortion vectors are utilized to model the distortion characteristics of the lens system and consequently to accomplish the desired image correction. FIG. 18 summarizes schematically the process of obtaining a lens model LM according to the teachings of FIGS. 15, 16, 17b. It is noted that for the purpose of completeness the lens system may be a fixed lens system 5 or a variable lens system 6 as described in the FIGS. 7-12.

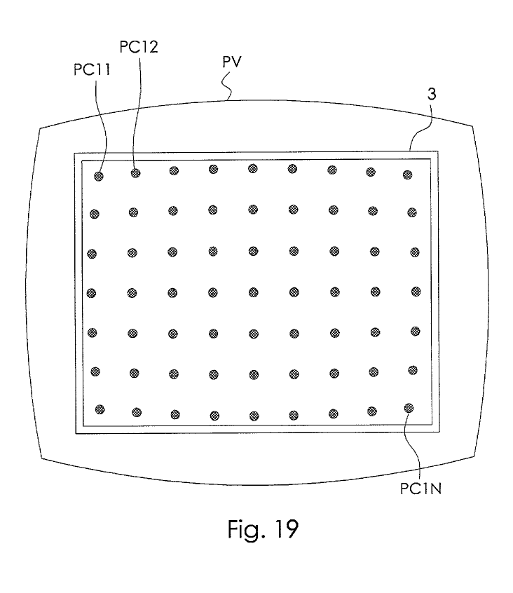

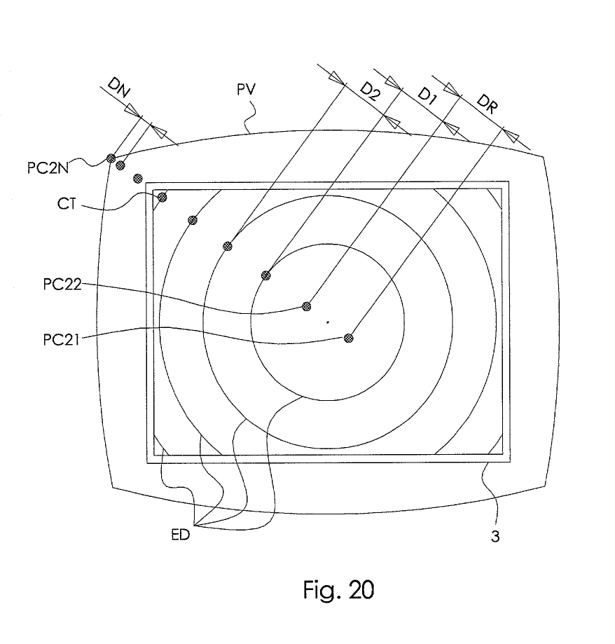

The spot clusters PC11-PC41 of the FIGS. 19-20 relied on in the following description are shown as single calibration control points for the purpose of simplicity. The scope of the first and second embodiment set forth in the below is not limited to a particular configuration of the spot clusters PC11-PC41, which may also be just single spot images PT. Furthermore, the scope of the first and second embodiment is not limited to a 3D scanner but may be applied to any imaging system having a 2D area-array sensor and a laser system suitable to provide laser spots and their 3D scene locations in accordance with the teachings of the first, second embodiment.

Method of Calibrating the System

In a first embodiment applied to the most general case, where the distortion type is an asymmetric, arbitrary and/or an unknown distortion, an array of projected spots/clusters PC1-PC1N may be set within the scanning area SA. FIG. 19 illustrates how such an array may be projected onto the sensor 3. For each projected spot and/or projected spots/clusters, PC11-PCN the image coordinates and the distortion vectors DV1, DV2 are determined in the same way as described above. Using the distortion vectors DV1, DV2, distortion correction vectors for each image pixel 31 are determined by interpolation.

The more dense the array is defined, the more accurately may the lens model LM and consequently the distortion map be extrapolated from the increased number of distortion vectors DV1, DV2. However, an increase in array density and extrapolation precision requires more processing time. For example, a calibration array with 8 by 8 spot clusters TC (each cluster having 3 by 3 spots) requires a total of 576 laser firings that need to be performed. Considering the optimal case where 9 projected clusters PC may be imaged during a single exposure time E1, eight images 101 need to be taken with laser spots which may be compared to a single image 12. Furthermore, each distortion vector DV1, DV2 carries information about distortion amount and distortion orientation. Thus, a lens model LM and/or distortion map may be a two-dimensional matrix which additionally consumes processing power when applied to correct the distorted image, because each pixel PX of the image must be individually corrected with orientation and distance. Therefore, this method is preferably applied in cases, where the distortion type is unknown or arbitrary as exemplarily illustrated in FIG. 1c.

The most common lens distortions we face are a combination of radial and tangential distortions. To address these distortions, we developed a mathematical distortion model that relies on a trace matrix, described with reference to FIG. 19. In this approach, the radial and tangential distortions are represented in a distortion function. The distortion function is then applied to correct optical scene images, map colors onto the scan data, and determine a line of sight from a user selected image location. To correct the optical scene images, a distortion map is generated from the distortion function. To map colors onto the scan data, a projection map is generated in conjunction with the distortion function. To determine a line of sight, an inverse projection map is generated in conjunction with the distortion function.

If only radially symmetric distortion of a lens system needs to be addressed, the calibration array may be simplified to a linear array of projected spots/clusters PC21-PC2N, as shown in FIG. 20. To implement this approach, the center of the radial distortions must be known. In accordance with the teachings of FIGS. 1a and 1b, each distortion vector DV1, DV2 derived from one of the projected traces/clusters PC21-PC2N represents the distortion at the entire distortion circle ED. In the case of radial distortion, the distortion vector DV1, DV2 is in radial direction. Thus, the distortion information from a distortion vector DV1, DV2 is applied to the distortion circle ED as a one dimensional offset information. All concentrically arrayed distortion circles are computationally combined to a one dimensional matrix since each pixel needs to be corrected in radial direction only.

A radially distorted image is essentially distortion free in the proximity of the image center IC. The present invention takes advantage of this attribute to use the projected clusters/traces PC21 and PC22 to derive information about the magnification with which the scenery is projected onto the sensor 3. Since the projected clusters/spot PC21, PC22 are in the essentially undistorted part of the projected image PI, the magnification is simply calculated by computationally comparing the image distance DR of the projected clusters/spot with trajectory offset SG of the corresponding spot clusters TC. Since the scene location of the spots/clusters PC21, PC22 is provided by the laser device, their angular offset relative to the optical axis of the camera may be easily computed. The angular offset again may be compared to the image distance DR to derive information about magnification. This method also captures magnification discrepancies due to varying distances of the imaged scene relative to the camera.

In this application, there is no need for deriving information about magnification resulting from user defined lens settings, which reduces the control and design effort of imaging system and/or lens system significantly.

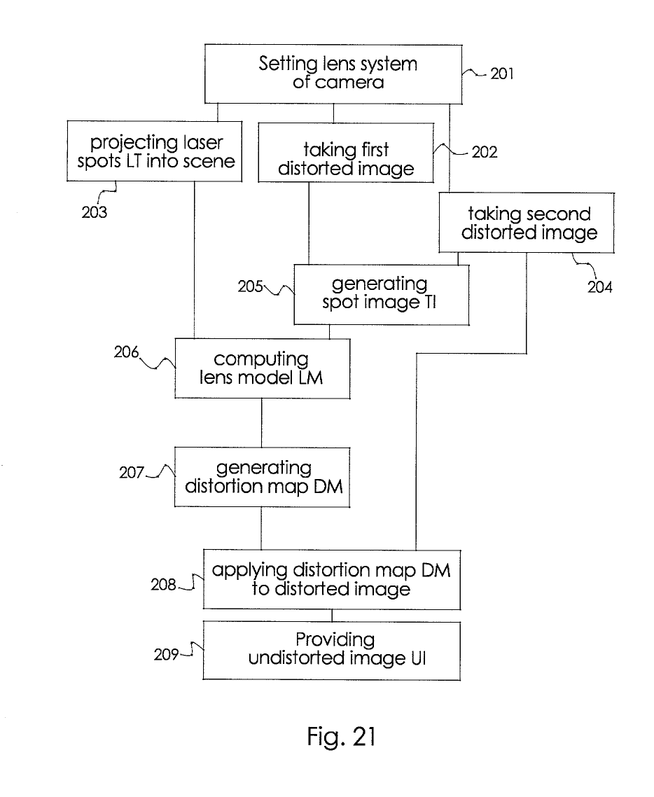

After the lens system is modeled with a method of one of the several embodiments described above, a distortion map is generated and applied to the distorted image pixel by pixel. The distortion map may be applied to any other picture taken with lens settings for which the distortion map is created. Since the lens system may be modeled and the distortion map computationally generated in a fraction of a second, it may be generated at the time a user takes an image. The block diagram of FIG. 21 illustrates such case. The flow of time is considered in FIG. 21 from top to bottom. After the lens system has been set in step 201, the user takes in step 202 an image from the scene. At the time of step 202, the laser spot(s) LT is/are projected onto the scene in step 203. Immediately after that, step 204 follows where the second image is taken while the laser 7 is deactivated. Lens settings may be automatically locked during that time. Then, step 205 is performed where the background information is subtracted from image and the spot image TI is generated. In the following step 206, the image location of spot pixel PX or of the cluster center CC is computationally compared with the reference spot RT or with the reference center RC, which results in the lens model LM. Once the lens system has been modeled, the distortion map DM is generated in step 207. In step 208, the distortion map is applied to process the second image with the result of an undistorted image UI. In a final step 209, the undistorted image UI may be displayed or otherwise processed or stored. The lens model may be eventually stored and applied when identical lens settings are observed. Also, the distortion map DM may be kept available as long as the lens settings remain unchanged.

Finally a detailed procedure for acquiring calibration control points as described in the previous paragraphs for either the wide cameras 41, 42 is exemplarily described in the following. Once three-dimensional coordinate data and the corresponding image pixel location data are obtained for all defined control points, the parameters of the current state of the variable-parameter camera optics may be determined according to one of several possible procedures, including those defined by Heikkilä and Silvén (1996) and Willson (1994).

The camera calibration parameters are determined according to the procedure described in the following paragraphs. A pinhole camera model is used in which object points are linearly projected onto the image plane through the center of projection of the optical system. In the following discussion, the object coordinate system is assumed to be equivalent to the coordinate system of the integrated laser scanning system 20-24. The intent of the camera calibration in one embodiment of the invention is to produce the following mappings:

In order to display a corrected (undistorted) image on a display device, a distortion function F(s₁, s₂) (c₁, c₂) between normalized coordinates (s₁, s₂) and camera pixel coordinates (c₁ ,C₂) is needed.

In order to specify color information from the corrected 2D image for any 3D object coordinate (texture mapping), a projection map D(p₁, p₂, p₃)=(s₁ , s₂) between a point in the object coordinate system (p₁, p₂, p₃) and a point in the normalized image coordinate system (s₁, s₂) is needed.

In order to utilize the corrected image for defining the scanning area SA, an inverse projection map is needed which maps a normalized coordinate (s₁, s₂) to a line of sight in the object coordinate system.

According to the pinhole camera model, if p=(p₁, p₂, p₃) is an arbitrary point in object coordinates then the mapping to ideal camera image coordinates (c₁, c₂) (without distortion) is specified as

$$\begin{matrix}w = Mp \\ o r \\ [ \begin{matrix}{w}_{1} \\ {w}_{2} \\ {w}_{3}\end{matrix} ] = [ \begin{matrix}{m}_{11} & {m}_{12} & {m}_{13} & {m}_{14} \\ {m}_{21} & {m}_{22} & {m}_{23} & {m}_{24} \\ {m}_{31} & {m}_{32} & {m}_{33} & {m}_{34}\end{matrix} ] [ \begin{matrix}{p}_{1} \\ {p}_{2} \\ {p}_{3}\end{matrix} ] \\ a n d & [ 4 ] \\ [ \begin{matrix}{c}_{1} \\ {c}_{2}\end{matrix} ] = [ \begin{matrix}\frac{{w}_{1}}{{w}_{3}} \\ \frac{{w}_{2}}{{w}_{3}}\end{matrix} ] , & [ 5 ]\end{matrix}$$

where the 3×4 matrix M is known as the Direct Linear Transform (DLT) matrix.

It should be noted that the DLT is a more general case of the traditional pinhole camera model, which can be specified as

$$[ \begin{matrix}{x}_{1} \\ {y}_{2} \\ {z}_{3}\end{matrix} ] = [ \begin{matrix}{R}_{x1} & {R}_{x2} & {R}_{x3} \\ {R}_{y1} & {R}_{y2} & {R}_{y3} \\ {R}_{z1} & {R}_{z2} & {R}_{z3}\end{matrix} ] ( p - {p}_{0} ) \qquad [ 6 ]$$

where (x₁, x₂, x₃) is a point the 3-dimensional camera coordinates, (p−p₀) represents the translation between the object and camera coordinate systems (p₀ is the origin of the camera coordinate system), and R is an orthonormal rotation matrix. The transformation to image coordinates is given by

$$\begin{matrix}{c}_{1} = f \frac{{x}_{1}}{{x}_{3}} + {c}_{x} & [ 7 ] \\ {c}_{2} = f \frac{{x}_{2}}{{x}_{3}} + {c}_{y} , & [ 8 ]\end{matrix}$$

where s is the aspect ratio (between the x and y camera axes), f is the effective focal length, and (cₓ, c_{y}) specifies the image center IC. The parameters p₀, R, f , s, cₓ, and c_{y} can be extracted from the DLT.

Since the pinhole model does not incorporate the effects of optical distortion, additional corrections are included. As stated above, radial distortion induces displacement of image points in a radial direction from the image center IC. Radial distortion is expressed as follows:

$$[ \begin{matrix}{x}^{r} \\ {y}^{r}\end{matrix} ] = [ \begin{matrix}x ( 1 + {K}_{1} {r}_{i}^{2} + {K}_{2} {r}_{i}^{4} + … ) \\ y ( 1 + {K}_{1} {r}_{i}^{2} + {K}_{2} {r}_{i}^{4} + … )\end{matrix} ] \qquad [ 9 ]$$

where K1, K2, . . . are the 1^{st} order, 2^{nd} order, . . . radial distortion coefficients, and

x=c₁−cₓ (10)

$$y = \frac{{c}_{2} - {c}_{y}}{s} \qquad [ 11 ]$$

r=\sqrt{x²+y²}. (12)

Tangential or decentering distortion is also common in camera lens systems and can be modeled as:

$$[ \begin{matrix}{x}^{t} \\ {y}^{t}\end{matrix} ] = [ \begin{matrix}2 {P}_{1} x y + {P}_{2} ( {r}^{2} + 2 {x}^{2} ) \\ {P}_{1} ( {r}^{2} + 2 {y}^{2} ) + 2 {P}_{2} x y\end{matrix} ] \qquad [ 13 ]$$

where P₁ and P₂ are the tangential distortion coefficients. Distorted image coordinates are expressed as

c₁=x^{r}+x^{t}+cₓ (14)

c₂=s(y^{r}+y^{t})+c_{y} (15)

Estimation of the camera calibration parameters is achieved in two steps. The first step ignores the nonlinear radial and tangential distortion coefficients and solves for the DLT matrix using a linear parameter estimation method. The second step is an iterative nonlinear estimation process that incorporates the distortion parameters and accounts for the effects of noise in the calibration control point measurements. The results of the direct solution are used as the initial conditions for the nonlinear estimation.

The linear estimation method is used to solve a simultaneous set of linear equations as follows. Given a set of N corresponding object

$${\{ ( {P}_{n1} , {P}_{n2} , {P}_{n3} ) \}}_{n = 1}^{N}$$

and image coordinates

$${\{ ( {C}_{n1} , {C}_{n2} ) \}}_{n = 1}^{N}$$

with N>50 and with a plurality of object planes represented, a set of linear equations can be formed as follows. Note that from equation [5],

wᵢ−cᵢw₃=0,i=1,2 . (17)

Since a scale factor for magnification may be applied to the DLT matrix, we can assume that m₃₄=1. Then from equation [4],

Pmᵢₗ+Pₙ₂mᵢ₂+Pₙ₃mₙ₃mₜ₃+mᵢ₄−CₙᵢPₙ₁m₃₁−CₙᵢPₙ₂m₃₂−CₙᵢP₃m₃₃=Cₙᵢ,i=1,2 (17)

This provides an over-determined system of 2N linear equations with 11 unknowns (mᵢⱼ), which can be solved using a pseudo-inverse least-squares estimation method.

A nonlinear optimization process may be used to estimate the distortion parameters and further optimize the 11 linear parameters as follows. In one embodiment of the invention, the Levenberg-Marquardt nonlinear optimization method (Levenberg, 1944; Marquardt, 1963) may be used. If M represents the camera model including distortion, then M is a function that maps object coordinates to corrected image coordinates. An error metric can be formed as

$$ϵ = {\sum }_{n = 1}^{N} {( M ( {P}_{n} ) - {C}_{n} )}^{2} . \qquad [ 18 ]$$

The model M is dependent upon 15 parameters

$${\{ {α}_{j} \}}_{j = 1}^{15}$$

that include the 11 DLT parameters and the 4 nonlinear distortion parameters. The linear DLT solution is used as the initial guess for the first 11 parameters, and the set of 15 parameters is optimized by minimizing the error metric (equation [18]). The Levenberg-Marquardt method assumes a linear approximation of the behavior of M from the first partial derivatives. That is we solve of Δⱼ such that

$${\sum }_{j = 1}^{15} {Δ}_{j} \frac{\partial M}{\partial {α}_{j}} = {C}_{n} - M ( {P}_{n} ) \qquad [ 19 ]$$

in a least squares sense. On each iteration, the parameters αⱼ are updated as

αⱼ=αⱼ+Δⱼ . (20)

The iterations are terminated when the error metric reaches a local minimum or when the Δⱼ converges to zero.

In order to complete the calibration process, a raw camera image must be undistorted or warped based on the camera calibration parameters so that a corrected image can be viewed on a display device 17. In one embodiment of the invention, image correction is achieved by establishing the rotated distortion map F, which corresponds the distortion curves DC1-DCNN., which takes a normalized coordinate of a rectangular grid and maps the value onto a pixel in the rotated, distorted (raw) image. The corrected image pixel is then filled with the weighted average of the four pixels nearest to the mapped pixel coordinate in the raw image. The rotated distortion mapping F[(s₁, s₂)]=(c₁, c₂) is specified as follows. Assume that in the corrected image the center is (0.5, 0.5) and the rotation relative to the object coordinate system y-axis is θ. First, rotate the corrected coordinate (s₁,s₂) by −θ about the image center:

x=r[(s₁−0.5)cosθ+(s₂−0.5)sinθ] [21]

x=r[(s₁−0.5)sinθ+(s₂−0.5)cosθ] [22]

where r is a scale factor which relates the scale of the normalized coordinates to the raw image. The distorted camera image coordinates (c′₁, c′₂)are then calculated using equations [9-15].

The final mapping that is needed for the implementation of the current invention is that required for targeting, or the inverse projection map from normalized corrected coordinates (s₁, s₂) to a line of sight in the object coordinate system. Since the corrected (undistorted) image actually represents a pinhole model of the camera, we can define a DLT matrix that represents the transform from object coordinates to normalized corrected image coordinates. The DLT matrix D that maps object coordinates to normalized image coordinates is defined as follows. Since the mapping from normalized corrected image coordinates (s₁, s₂) to undistorted camera coordinates (c₁, c₂) is linear (rotation, translation, and scaling), it is also invertible. Hence, define the matrix P such that

$$[ \begin{matrix}{s}_{1} \\ {s}_{2} \\ 1\end{matrix} ] = [ \begin{matrix}{p}_{11} & {p}_{12} & {p}_{13} \\ {p}_{21} & {p}_{22} & {p}_{23} \\ 0 & 0 & 1\end{matrix} ] [ \begin{matrix}{c}_{1} \\ {c}_{2} \\ 1\end{matrix} ] . \qquad [ 23 ]$$

Since the matrix M (equation [5]) maps object coordinates to (c₁, c₂), the matrix

D=PM [24]

will be the DLT matrix for the mapping of object coordinates to corrected image coordinates, or

$$D [ \begin{matrix}{p}_{1} \\ {p}_{2} \\ {p}_{3} \\ 1\end{matrix} ] = t [ \begin{matrix}{s}_{1} \\ {s}_{2} \\ 1\end{matrix} ] \qquad [ 25 ]$$

For targeting, we require the inverse of this mapping, which can be derived as follows:

$$\begin{matrix}[ \begin{matrix}{d}_{11} & {d}_{12} & {d}_{13} \\ {d}_{21} & {d}_{22} & {d}_{23} \\ {d}_{31} & {d}_{32} & {d}_{33}\end{matrix} ] p + [ \begin{matrix}{d}_{14} \\ {d}_{24} \\ {d}_{34}\end{matrix} ] = t [ \begin{matrix}{s}_{1} \\ {s}_{2} \\ 1\end{matrix} ] & [ 26 ] \\ p = - {d}^{- 1} [ \begin{matrix}{d}_{14} \\ {d}_{24} \\ {d}_{34}\end{matrix} ] + t {d}^{- 1} [ \begin{matrix}{s}_{1} \\ {s}_{2} \\ 1\end{matrix} ] = {p}_{0} + t {d}^{- 1} [ \begin{matrix}{s}_{1} \\ {s}_{2} \\ 1\end{matrix} ] \\ w h e r e & [ 27 ] \\ d = [ \begin{matrix}{d}_{11} & {d}_{12} & {d}_{13} \\ {d}_{21} & {d}_{22} & {d}_{23} \\ {d}_{31} & {d}_{32} & {d}_{33}\end{matrix} ] & [ 28 ]\end{matrix}$$

The matrix d⁻¹ and the point p₀ (the camera position relative to the origin of the object coordinate system) are all that are required to compute the line of sight from a pixel in the corrected image.

Since the camera 42 looks through the scanning mirrors 12, 13, the map D from object coordinates to normalized coordinates depends upon the two mirror angles. When a Cartesian coordinate system is reflected through two mirror planes, the composition of the two reflections results in an orientation-preserving isometry A on the coordinate system

A(θ₁,θ₂): [symbol] ³→ [symbol] ³. [29]

Now A is a function of the mirror positions, which are in turn functions of the mirror angles. The equality θ₁=θ₂=0 holds when both mirror angles are in the middle of the scanning range, which in turn places the laser beam in the approximate center of the scanner (and camera) FOV. From the calibration of the laser scanning system, we have accurate knowledge of

C(θ₁, θ₂)=A(θ₁,θ₂)·A⁻¹(0,0). [30]

C is also an isometry, which is the identity matrix at (0,0). Therefore, the object coordinates obtained for the calibration control points must be transformed by C⁻¹(θ₁,θ₂)(P₁, P₂, P₃) before the calibration parameters for the camera 42 are estimated. While the mapping process used for image correction will be the same as for the wide field of view camera images, the mapping from object coordinates to camera coordinates (required for texture mapping) will only be valid when both mirror angles are zero. The general equation for D is then

D(θ₁,θ₂)=D(0,0)·C⁻¹(θ₁,θ₂).

Accordingly, the scope of the invention described in the specification above is set forth by the following claims and their legal equivalent.

What is claimed is:

1. An imaging apparatus comprising:
a camera including an imaging array and a lens system for projecting an image of an object onto the array, said lens system inducing some distortion in the projected image;
a laser for generating a laser beam;
a scanner for scanning the laser beam over the object in a manner so that laser light reflected from the object is imaged by the lens system onto the array, said scanner generating information corresponding to the position of the laser beam on the object; and
a processor for controlling the scanner and for comparing the position of the laser light imaged by the camera onto the array with position information received from the scanner to determine the distortion in the image induced by the lens system.

2. An apparatus as recited in claim 1 further including a display for displaying the image from the array and wherein said processor modifies the image to compensate for the determined distortion.

3. An apparatus as recited in claim 2 wherein distortion information is stored and recalled by the processor to correct distortion in subsequent images.

4. An apparatus as recited in claim 1 wherein the laser is pulsed and directed to generate a plurality of illuminated spots on the object.

5. An apparatus as recited in claim 4 wherein the illuminated spots used to determine distortion fall along a line.

6. An apparatus as recited in claim 4 wherein the illuminated spots used to determine distortion fall on a grid pattern.

7. An apparatus as recited in claim 1 wherein the scanner is controlled to generate a cluster of illuminated laser spots on the object to facilitate detection at the array.

8. An apparatus as recited in claim 7 wherein the processor determines the center of the cluster of spots using centroid or moment algorithm.

9. An apparatus as recited in claim 7 wherein the cluster of spots is configured based on the resolution of the image array.

10. An apparatus as recited in claim 1 wherein an image of the object is obtained when the laser is not illuminating the object and wherein that image is used by the processor to enhance the imaging of the laser light.

11. An apparatus as recited in claim 10 wherein the image of the object which is obtained when the laser is not illuminating the object is subtracted from the image of the object when the laser is illuminating the object.

12. An apparatus as recited in claim 1 wherein processor uses information from the scanner to generate a model of the object and wherein corrected image information is used to add texture to the model.

13. A method of determining the distortion created by the lens system of a camera, wherein said lens system projects an image onto an array, said method comprising the steps of:
directing a laser beam to reflect off an object in a manner so that the reflected light is imaged by the array; and
comparing the position of the laser light falling on the array with independent information about the position of the laser beam on the object to determine the imaging model of and distortion created by the lens system.

14. A method of determining the distortion created by the lens system of a camera, wherein said lens system projects an image onto an array, said method comprising the steps of:
directing a laser beam with a scanner to reflect off an object in a manner so that the reflected light is imaged by the array, said scanner generating position information; and
comparing the position of the laser light falling on the array with position information generated by the scanner to determine the distortion created by the lens system.

15. The method of claim 14 further including the step of displaying an image based on the light imaged by the array, with the image being modified in response to the determination of said distortion of said lens system.

16. A method as recited in claim 14 wherein the distortion information which has been determined is stored and later recalled to correct distortion in subsequent images.

17. A method as recited in claim 14 wherein the scanner is controlled to generate a cluster of illuminated laser spots on the object to facilitate detection at the array.

18. A method as recited in claim 17 wherein the center of the cluster of spots is determined using centroid or moment algorithm.

19. A method as recited in claim 14 further including the step of obtaining an image of the object when the laser is not illuminating the object and wherein that image is used to enhance the imaging of the laser light.

20. A method as recited in claim 19 wherein the image of the object which is obtained when the laser is not illuminating the object is subtracted from the image of the object when the laser is illuminating the object.

21. An imaging apparatus comprising:
a camera including an imaging array and a lens system for projecting an image of an object onto the array;
a laser for generating a laser beam;
a scanner for scanning the laser beam over the object in a manner so that laser light reflected from the object is imaged by the lens system onto the array, said scanner generating information corresponding to the position of the laser beam on the object; and
a processor for controlling the scanner and for comparing the position of the laser light imaged by the camera onto the array with position information received from the scanner to determine an optical imaging model of the camera.
